(19) United States
(12) Patent Application Publication
(10) Pub. No.: US 2026/0329742 A1
(43) Pub. Date: Oct. 22, 2026

(54) TRANSLATION OF USER PROMPTS AND DEBUGGING ERRORS FOR INTERACTION WITH AN ARTIFICIAL INTELLIGENCE ENGINE

(71) Applicant: Microchip Technology Inc., Chandler, AZ (US)

(72) Inventor: Valentin Stoia, Bucharest (RO)

(73) Assignee: Microchip Technology Inc., Chandler, AZ (US)

(21) Appl. No.: 19/250,642

(22) Filed: Jun. 26, 2025

Related U.S. Application Data
(60) Provisional application No. 63/792,759, filed on Apr. 22, 2025.

(51) Int. Cl. G06F 11/3698; G06F 8/71

(52) U.S. Cl. CPC G06F 11/3698; G06F 8/71

(57) ABSTRACT

A system and method for translating user prompts and debugging and build errors for use by an artificial intelligence engine to draft a software code file are disclosed. The method may include receiving a user prompt. The method may also include translating the user prompt into an instruction for an artificial intelligence interface. The method may additionally include transmitting the instruction to the artificial intelligence interface. The method may include receiving a code file from the artificial intelligence interface. The method may also include building an executable software program from the code file. The method may additionally include determining whether a build error exists in the executable software program. The method may further include debugging the executable software program.

### PRIORITY

This application claims priority to U.S. Provisional Patent Application No. 63/792,759 filed Apr. 22, 2025, the contents of which are hereby incorporated in their entirety.

### TECHNICAL FIELD

The present disclosure relates to the development of software code, and in particular, to a system and method for translating user prompts and debugging and build errors for use by an artificial intelligence engine to draft a software code file.

### BACKGROUND

Artificial intelligence (AI)-powered chatbots and coding assistants are increasingly integrated into the software development process, acting as tools rather than replacements for human programmers. Developers may use these assistants by providing natural language prompts describing the requested functionality, such as “write a Python function to sort a list of dictionaries by a specific key,” or by asking for explanations of existing code blocks. The AI engine may then generate code snippets, suggest autocompletions for lines of code, identify potential bugs and propose fixes, translate code between different programming languages, or even help refactor existing code for better readability or performance. This interaction allows developers to accelerate routine coding tasks, overcome specific challenges, and focus more on higher-level design and architecture. The developer may use the AI-generated code to update the developer's project and test and debug the project.

### SUMMARY OF THE INVENTION

Aspects provide systems and methods for translating user prompts and debugging and build errors for use by an artificial intelligence engine to draft a software code file. Examples of the present disclosure may include a non-transitory computer-readable medium comprising instructions executable by a processor. The instructions may cause the processor to receive a user prompt. The instructions may also cause the processor to translate the user prompt into an instruction for an artificial intelligence interface. The instructions may additionally cause the processor to transmit the instruction to the artificial intelligence interface. The instructions may cause the processor to receive a code file from the artificial intelligence interface. The instructions may also cause the processor to build an executable software program from the code file. The instructions may additionally cause the processor to determine whether a build error exists in the executable software program. The instructions may further cause the processor to debug the executable software program.

In combination with any of the above examples, the instructions may be further executable by the processor to draft a second instruction to the artificial intelligence interface based on the build error. The instructions may also cause the processor to transmit the second instruction to the artificial intelligence interface.

In combination with any of the above examples, the instructions may be further executable by the processor to compare, during the debugging, a variable in the executable software program to an expected value. The instructions may also cause the processor to draft, when the variable does not match the expected value, a third instruction to the artificial intelligence interface when the variable does not match the expected value. The instructions may further cause the processor to transmit the third instruction to the artificial intelligence interface.

In combination with any of the above examples, translating the user prompt into the instruction for the artificial intelligence interface may include instructing the artificial intelligence interface to insert a breakpoint in the code file.

In combination with any of the above examples, the user prompt may include a path identification to a software code in which the code file is to be included.

In combination with any of the above examples, the instructions may be further executable by the processor to provide a standard code parameter to the artificial intelligence interface. The instructions may also cause the processor to instruct the artificial intelligence interface to create the code file according to the standard code parameter.

In combination with any of the above examples, the instruction for the artificial intelligence interface may include a condition to the user prompt, instructions to analyze an existing code file, and a response format.

Alone or in combination with any of the above examples, examples of the present disclosure may include a method. The method may include receiving a user prompt. The method may also include translating the user prompt into an instruction for an artificial intelligence interface. The method may additionally include transmitting the instruction to the artificial intelligence interface. The method may include receiving a code file from the artificial intelligence interface. The method may also include building an executable software program from the code file. The method may additionally include determining whether a build error exists in the executable software program. The method may further include debugging the executable software program.

In combination with any of the above examples, the method may include drafting a second instruction to the artificial intelligence interface based on the build error. The method may also include transmitting the second instruction to the artificial intelligence interface.

In combination with any of the above examples, the method may include comparing, during the debugging, a variable in the executable software program to an expected value. The method may also include drafting, when the variable does not match the expected value, a third instruction to the artificial intelligence interface when the variable does not match the expected value. The method may further include transmitting the third instruction to the artificial intelligence interface.

In combination with any of the above examples, translating the user prompt into the instruction for the artificial intelligence interface may include instructing the artificial intelligence interface to insert a breakpoint in the code file.

In combination with any of the above examples, the user prompt may include a path identification to a software code in which the code file is to be included.

In combination with any of the above examples, the method may include providing a standard code parameter to the artificial intelligence interface. The method may also include instructing the artificial intelligence interface to create the code file according to the standard code parameter.

In combination with any of the above examples, the instruction for the artificial intelligence interface may include a condition to the user prompt, instructions to analyze an existing code file, and a response format.

Alone or in combination with any of the above examples, examples of the present disclosure may include a system. The system may include a processor. The system may also include a non-transitory computer-readable medium. The non-transitory computer-readable medium may include instructions executable by the processor. The instructions may cause the processor to receive a user prompt. The instructions may also cause the processor to translate the user prompt into an instruction for an artificial intelligence interface. The instructions may additionally cause the processor to transmit the instruction to the artificial intelligence interface. The instructions may cause the processor to receive a code file from the artificial intelligence interface. The instructions may also cause the processor to build an executable software program from the code file. The instructions may additionally cause the processor to determine whether a build error exists in the executable software program. The instructions may further cause the processor to debug the executable software program.

In combination with any of the above examples, the instructions may be further executable by the processor to draft a second instruction to the artificial intelligence interface based on the build error. The instructions may also cause the processor to transmit the second instruction to the artificial intelligence interface.

In combination with any of the above examples, the instructions may be further executable by the processor to compare, during the debugging, a variable in the executable software program to an expected value. The instructions may also cause the processor to draft, when the variable does not match the expected value, a third instruction to the artificial intelligence interface when the variable does not match the expected value. The instructions may further cause the processor to transmit the third instruction to the artificial intelligence interface.

In combination with any of the above examples, translating the user prompt into the instruction for the artificial intelligence interface may include instructing the artificial intelligence interface to insert a breakpoint in the code file.

In combination with any of the above examples, the instructions may be further executable by the processor to provide a standard code parameter to the artificial intelligence interface. The instructions may also cause the processor to instruct the artificial intelligence interface to create the code file according to the standard code parameter.

In combination with any of the above examples, the instruction for the artificial intelligence interface may include a condition to the user prompt, instructions to analyze an existing code file, and a response format.

### BRIEF DESCRIPTION OF THE DRAWINGS

The figures illustrate examples of systems and methods for translating user prompts and debugging and build errors for use by an artificial intelligence engine to draft a software code file.

FIG. 1 illustrates a block diagram of a system for translating user prompts and debugging and build errors for use by an artificial intelligence engine to draft a software code file, according to examples of the present disclosure;

FIG. 2 illustrates a method for translating user prompts and debugging and build errors for use by an artificial intelligence engine to draft a software code file, according to examples of the present disclosure; and

FIG. 3 illustrates a more detailed method for translating user prompts and debugging and build errors for use by an artificial intelligence engine to draft a software code file, according to examples of the present disclosure

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect of the invention, a system and method for translating user prompts and debugging and build errors for use by an artificial intelligence engine to draft a software code file are provided. The system may include an automation script as an interface between a user and artificial intelligence (AI) engine, a large language model (LLM), a chatbot, or any combination thereof, to generate or update embedded software code, build the code, and debug the code to analyze variables in a simulator or with a physical device (e.g., a microcontroller). The automation script may operate in a loop until the generated code is deemed acceptable. Using the disclosed system and method may improve the process for developing software code by reducing the development cost, reducing the development time, and improving the quality of the software code.

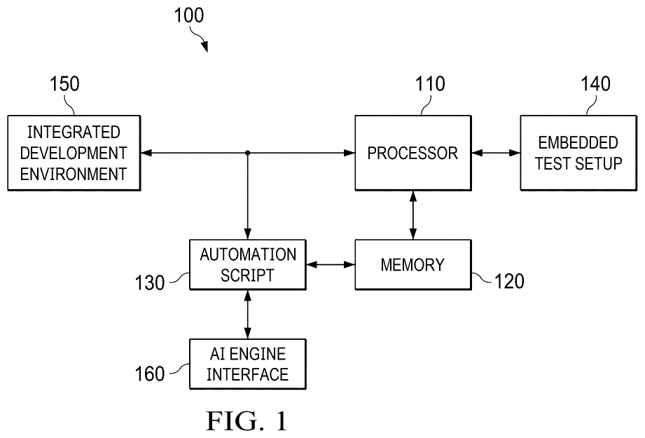

FIG. 1 illustrates a block diagram of a system for translating user prompts and debugging and build errors for use by an artificial intelligence engine to draft a software code file, according to examples of the present disclosure. System 100 may include processor 110, memory 120, automation script 130, embedded test setup 140, integrated development environment (IDE) 150, and AI engine interface 160.

Processor 110 may comprise any system, device, or apparatus operable to interpret or execute logic instructions, and may include, without limitation a microprocessor, microcontroller, digital signal processor (DSP), application specific integrated circuit (ASIC), or any other digital or analog circuitry to interpret or execute program instructions and process data.

Memory 120 may include one or more type of non-transitory computer-readable memory device to store logic instructions, for example, read-only memory (ROM), random access memory (RAM, SRAM, DRAM), electrically erasable programmable read-only memory (EEPROM), a Personal Computer Memory Card International Association (PCMCIA) card, flash memory, magnetic storage, opto-magnetic storage, hardware registers, or any suitable selection or array of volatile or non-volatile memory.

Automation script 130 may comprise software or instructions executable by a processor and stored in non-transitory computer-readable medium (e.g., memory 120) and executable by one or more processors (e.g., processor 110). Automation script 130 may be a script created in a software language (e.g., Python, JavaScript, TypeScript, C/C++) to interface with an AI engine, an LLM, or a chatbot using a public application programming interface (API) (e.g., AI engine interface 160). In some examples, automation script 130 may be integrated in IDE 150, described in more detail below. In other examples, automation script 130 may be separate from IDE 150.

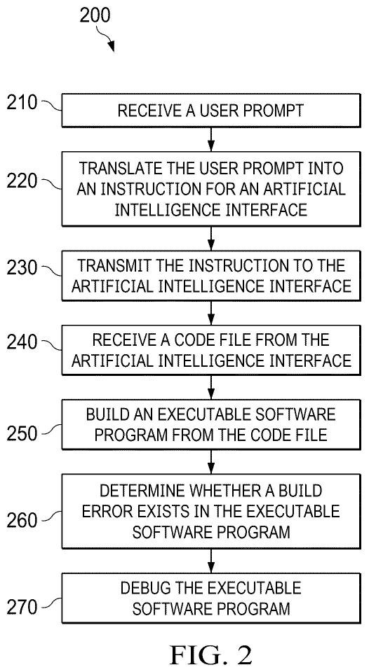

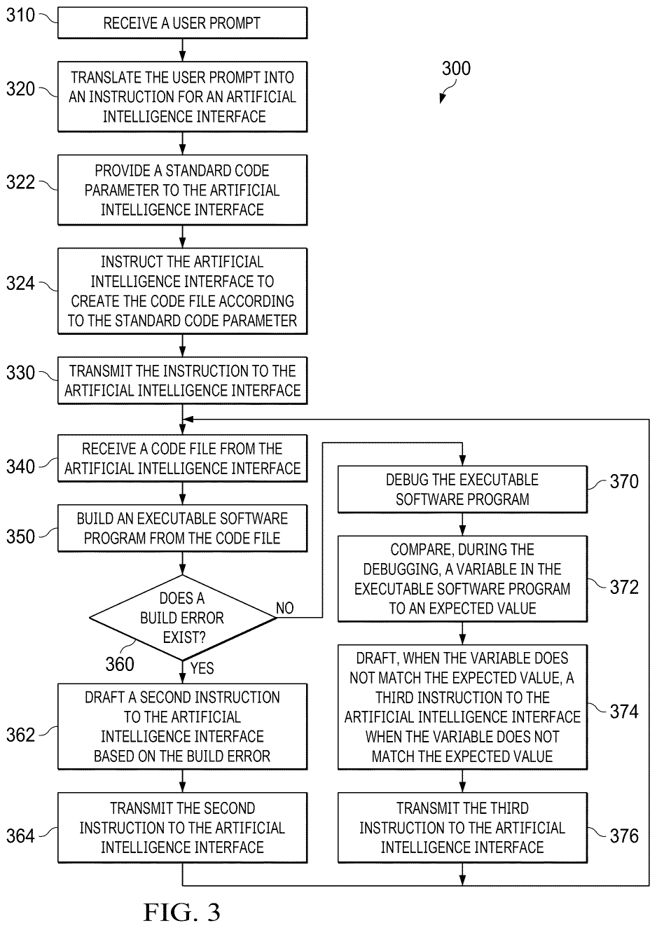

As described in more detail with respect to FIGS. 2 and 3, automation script 130, when executed by processor 110, may receive prompts from a user and translate the prompt to provide to the AI engine via AI engine interface 160. For example, the user prompt may request software code to perform a specified task. Automation script 130 may translate the user prompt, add additional conditions to the prompt, and communicate the translated user prompt to the AI engine. Automation script 130 may also receive build errors and debugging errors related to the software code produced by the AI engine. Automation script 130 may translate the errors into instructions for the AI engine to correct the errors and communicate the instructions to the AI engine via AI engine interface 160.

In some examples, automation script 130 may pretrain the AI engine using standardized libraries. The use of standardized libraries may result in the AI engine producing standardized code. The standardized libraries may include pre-written code modules and functions that may promote consistent coding style across project and within a company. Additionally, as automation script 130 uses the AI engine, the AI engine may learn the preferences and style of automation script 130 and the user of automation script 130 to improve the code generated by the AI engine in response to instructions provided by automation script 130.

Embedded test setup 140 may be used to debug the software code generated by the AI engine. Embedded test setup 140 may be used to evaluate the functionality, performance, reliability, or combinations thereof to ensure that the software code meets the specifications of automation script 130, the user, or both. In some examples, embedded test setup 140 may be a hardware setup. For example, embedded test setup 140 may include a debugger and a target microcontroller. Embedded test setup 140 may also include additional devices on a printed circuit board (PCB) or demo board for the purposes of performing integration testing. In other examples, embedded test setup 140 may be a simulator that simulates the functionality of a target microcontroller. For example, embedded test setup 140 may include a stimulus provided by an integrated development environment (e.g., MPLAB Stimulus).

Integrated development environment (IDE) 150 may include any automated or semi-automated system or systems for generating and analyzing software code. IDE 150 may be a software application that consolidates the tools developers use for writing, testing, and debugging code into a single graphical user interface. In some examples, IDE 150 may include a command line interface (CLI). In some examples, IDE 150 may be a product such as MPLAB® provided by Microchip Technology Inc. or Visual Studio Code provided by Microsoft. In some examples, IDE 150 may operate on a remote server accessed by a user. In other examples, IDE 150 may operate on a local computer used by the user.

Automation script 130 may leverage extensions in IDE 150 to issue commands to IDE 150. For example, automation script 130 may use a “Remote control” extension to issue commands to IDE 150 via a web socket. As another example, automation script 130 may use a “BreakpointIO” extension to generate breakpoints in the code. As an additional example, automation script 130 may use a “Problems: Copy” extension to extract build error messages such that the AI engine is not overwhelmed with large amounts of build errors, as described in more detail with respect to FIG. 2. As an additional example, automation script 130 may use a “Variable Saver” extension to save a file of variable values when the code reaches a breakpoint during the debugging process. In some examples, automation script 130 may be part of IDE 150. In other examples, automation script 130 may be separate from IDE 150.

AI engine interface 160 may allow automation script 130 to interact with an AI engine, an LLM, or a chatbot. For example, AI engine interface 160 may be an API that enables automation script to communicate with an AI engine. The AI engine may be an external chatbot provided by a third party (e.g., Google Gemini, Microchip Chatbot, Chat GPT, Grok, Meta Llama). In other examples, the AI engine may be an internal chatbot provided by the software developer. Depending on any licenses or services agreements between the user of automation script 130 and the provider of the AI engine, AI engine interface 160 may use an API access key when communicating with the AI engine. The access key may be subject to usage limits and limit the number of requests automation script 130 may make to the AI engine in a period of time. For example, the AI engine may limit automation script 130 to a predetermined number of requests per minute, per day, or per month. Where the AI engine limits the number of requests automation script 130 may make, automation script 130 may, when the limit is reached, exit execution and notify the user that the number of allowable requests has been reached, may low down execution to spread requests out to avoid reaching the limit, or may pause execution until additional requests are available (e.g., after the time period of limited requests has elapsed). Automation script 130 may resume execution automatically or after being prompted by the user.

FIG. 2 illustrates a method for translating user prompts and debugging and build errors for use by an artificial intelligence engine to draft a software code file, according to examples of the present disclosure. Method 200 may be at least partially implemented by system 100 shown in FIG. 1, for example by instructions executable by a processor and stored on a non-transitory computer-readable medium (e.g., automation script 130) by processor 110, or any other system operable to implement method 200. Although examples have been described above, other variations and examples may be made from this disclosure without departing from the spirit and scope of these disclosed examples.

Method 200 may begin at block 210 where the automation script may receive user prompt indicating for what functionality the user requests the automation script generate code. For example, the user may input “need to toggle PORTA0.” The user input may be provided in natural language. Prior to receiving the user prompt, the automation script may start executing. For example, the automation script may take control of an integrated development environment (e.g., IDE 150 shown in FIG. 1) to perform the steps of method 200 (e.g., generating and testing the code implementing the functionality requested by a user).

At block 220, the automation script may translate the user prompt into an instruction for an artificial intelligence engine. In some examples, the automation script may add conditions to the user prompt. For example, the automation script may add an instruction to insert “BREAKPOINT” comments or a dedicated no operation (NOP) line to use during debugging of the software code generated by the AI engine. In some examples, the automation script may also provide standardized libraries to the AI engine for use in responding to the instruction.

At block 230, the automation script may transmit the instruction to the artificial intelligence interface. The instructions may then be provided to an AI engine. For example, the automation script may provide instructions to the AI engine via an API. In some examples, the automation script may upload a zip file including a project for the AI engine to analyze. The zip file may include an existing code file for the AI engine to analyze when creating a response to the instruction.

At block 240, the automation script may receive a code file from the artificial intelligence interface. The AI engine may analyze the instructions from the automation script (transmitted at block 230) and analyze any existing code (if such code exists) and either update the existing code or generate new code responsive to the instructions. The AI engine may provide the software code to the automation script via the artificial intelligence interface. The code file may be written in any suitable language, including, but not limited to, C, C++, C#, Java, or Python.

At block 250, the automation script may build an executable software program from the code file. The automation script may leverage the integrated development environment to compile the code file into machine code that is an executable software program.

At block 260, the automation script may determine whether a build error exists in the executable software program. The build errors may include, for example, syntax errors, missing dependencies, or incorrect environment variables. If a build error exists, the automation script may provide further instructions to the AI engine, via the artificial intelligence interface, to instruct the AI engine to correct the build errors. If no build errors exist, method 200 may proceed to block 270.

At block 270, the automation script may debug the executable software program. The debugging process may use a simulator or actual hardware (e.g., embedded test setup 140 shown in FIG. 1) and may leverage the integrated development environment. The automation script may use the debugging process to identify errors in the executable software program.

Although FIG. 2 discloses a particular number of operations related to method 200, method 200 may be executed with greater or fewer operations than those depicted in FIG. 2. In addition, although FIG. 2 discloses a certain order of operations to be taken with respect to method 200, the operations comprising method 200 may be completed in any suitable order.

FIG. 3 illustrates a more detailed method for translating user prompts and debugging and build errors for use by an artificial intelligence engine to draft a software code file, according to examples of the present disclosure. Method 300 may be at least partially implemented by system 100 shown in FIG. 1, for example by instructions executable by a processor and stored on a non-transitory computer-readable medium (e.g., automation script 130) by processor 110, or any other system operable to implement method 300. Although examples have been described above, other variations and examples may be made from this disclosure without departing from the spirit and scope of these disclosed examples.

Method 300 may begin at block 310 where the automation script may receive user prompt indicating for what functionality the user requests the automation script generate code. For example, the user may input “need to toggle PORTA0.” The user input may be provided in natural language. Prior to receiving the user prompt, the automation script may start executing. For example, the automation script may take control of an integrated development environment (e.g., IDE 150 shown in FIG. 1) to perform the steps of method 300 (e.g., generating and testing the code implementing the functionality requested by a user).

At block 320, the automation script may translate the user prompt into an instruction for an artificial intelligence engine. In some examples, the automation script may add conditions to the user prompt. For example, the automation script may add an instruction to insert “BREAKPOINT” comments or a dedicated no operation (NOP) line to use during debugging of the software code generated by the AI engine. In some examples, the automation script may include a response format in the instruction. The response format may depend on the target application's programming or scripting language (e.g., C, C++, Java, Python).

In some examples, the automation script may prompt the user to indicate a path identification to a software code for the project. The path identification may be a location in memory (e.g., memory 120 shown in FIG. 1) where the software code generated by the AI engine is to be saved. The path identification may be to a new project or to an existing project. The automation script may include the path identification in the instruction. Where the path identification is to an existing project, the automation script may upload the existing parts of the project for the AI engine to reference when responding to the instruction. For example, the automation script may upload a zip file including a project for the AI engine to analyze and the instructions may instruct the AI engine to analyze one or more existing code files when preparing a response to the instruction.

At block 322, the automation script may provide a standard code parameter to the artificial intelligence interface. At block 324, the automation script may instruct the artificial intelligence interface to create the code file according to the standard code parameter. For example, the automation script may provide standardized libraries to the AI engine for use in responding to the instruction. The use of standardized libraries may result in the AI engine producing standardized code. The standardized libraries may include pre-written code modules and functions that may promote consistent coding style across project and within a company.

At block 330, the automation script may transmit the instruction to the artificial intelligence interface. The instructions may then be provided to an AI engine. For example, the automation script may provide instructions to the AI engine via an API. In some examples, the automation script may upload a zip file including a project for the AI engine to analyze. The zip file may include an existing code file for the AI engine to analyze when creating a response to the instruction.

At block 340, the automation script may receive a code file from the artificial intelligence interface. The AI engine may analyze the instructions from the automation script (transmitted at block 330) and analyze any existing code (if such code exists) and either update the existing code or generate new code responsive to the instructions. The AI engine may provide the software code to the automation script via the artificial intelligence interface. The code file may be written in any suitable language, including, but not limited to, C, C++, C#, Java, or Python.

At block 350, the automation script may build an executable software program from the code file. The automation script may leverage the integrated development environment to compile the code file into machine code that is an executable software program.

At block 360, the automation script may determine whether a build error exists in the executable software program. The build errors may include, for example, syntax errors, missing dependencies, or incorrect environment variables. If a build error exists, method 300 may proceed to block 362. If no build errors exist, method 300 may proceed to block 370.

At block 362, the automation script may draft a second instruction to the artificial intelligence interface based on the build error. The second instruction may instruct the AI engine to modify the code file to correct the build error. The second instruction may be based on multiple build errors where multiple build errors are identified.

At block 364, the automation script may transmit the second instruction to the artificial intelligence interface. Method 300 may return to block 340 where, after the AI engine analyzes the second instruction and prepares a second code file in response to the second instruction, the AI engine provides the second code file to the automation script. Method 300 may loop through blocks 340, 350, 360, 362, and 364 until the automation script determines that the code has no build errors.

At block 370, the automation script may debug the executable software program. The debugging process may use a simulator or actual hardware (e.g., embedded test setup 140 shown in FIG. 1) and may leverage the integrated development environment. The automation script may use the debugging process to identify errors in the executable software program.

As part of the debugging process, the automation script may set one or more breakpoints on the code lines marked by the AI engine. The breakpoints may instruct the debugger to pause execution of the executable software program when the debugger reaches the breakpoint. The breakpoints may allow the automation script to inspect the state of the executable software program at the breakpoint, examine variables, and step through the code line by line.

Additionally, the automation script may create a temporary or “tag” version of the code to preserve the code before beginning the debugging process. The temporary version may include logs and comments.

At block 372, the automation script may compare, during the debugging process, a variable in the executable software program to an expected value. For example, the automation script may, at a given breakpoint identified in the executable software program, analyze one or more relevant variables or special function registers (SFRs) to determine if the variable or SFR has the expected value for the purpose for which the executable software program is to be used. If the variables or SFRs do not have the expected values, method 300 may proceed to save the project (for example to the path identification) and notify the user that the project is complete. If the variables or SFRs have the expected values, method 300 may proceed to block 374.

At block 374, the automation script may draft, when the variable or SFR does not match the expected value, a third instruction to the artificial intelligence interface when the variable or SFR does not match the expected value. The third instruction may instruct the AI engine to modify the code file to correct the variables or SFRs resulting in unexpected values. The third instruction may be based on multiple variables or SFRs having unexpected values where unexpected values are identified.

At block 376, the automation script may transmit the third instruction to the artificial intelligence interface. Method 300 may then return to block 340 where, after the AI engine analyzes the second instruction and prepares a second code file in response to the second instruction, the AI engine provides the second code file to the automation script. Method 300 may loop through blocks 340 through 376 until the automation script determines that the code has no variables or SFRs having unexpected values.

At the end of the debugging process, the automation script may report possible bugs in the software internally to the user's organization. This reporting process may be used to improve the automation script, the software development process, or a combination thereof. The automation script may include observations and suggestions derived from the debugging process. The automation script may provide the observations and suggestions to the user for consideration. In some examples, the user may prompt the automation script to adopt one or more instructions, resulting in method 300 beginning again in response to the new user prompt.

Although FIG. 3 discloses a particular number of operations related to method 300, method 300 may be executed with greater or fewer operations than those depicted in FIG. 3. In addition, although FIG. 3 discloses a certain order of operations to be taken with respect to method 300, the operations comprising method 300 may be completed in any suitable order.

By looping through the software development process described with respect to FIGS. 2 and 3, an executable software program may be generated with little or no human intervention and in less time than software programs written by a human developer. Methods 200 and 300 may proceed through any number of loops to correct and optimize the code requested by the user (at blocks 210 and 310, respectively).

Although examples have been described above, other variations and examples may be made from this disclosure without departing from the spirit and scope of these disclosed examples.

1. A non-transitory computer-readable medium comprising instructions executable by a processor to:
receive a user prompt;
translate the user prompt into an instruction for an artificial intelligence interface;
transmit the instruction to the artificial intelligence interface;
receive a code file from the artificial intelligence interface;
build an executable software program from the code file;
determine whether a build error exists in the executable software program; and
debug the executable software program.

2. The non-transitory computer-readable medium of claim 1, wherein the instructions are further executable by the processor to:
draft a second instruction to the artificial intelligence interface based on the build error; and
transmit the second instruction to the artificial intelligence interface.

3. The non-transitory computer-readable medium of claim 1, wherein the instructions are further executable by the processor to:
compare, during the debugging, a variable in the executable software program to an expected value;
draft, when the variable does not match the expected value, a third instruction to the artificial intelligence interface when the variable does not match the expected value; and
transmit the third instruction to the artificial intelligence interface.

4. The non-transitory computer-readable medium of claim 1, wherein translating the user prompt into the instruction for the artificial intelligence interface includes instructing the artificial intelligence interface to insert a breakpoint in the code file.

5. The non-transitory computer-readable medium of claim 1, wherein the user prompt includes a path identification to a software code in which the code file is to be included.

6. The non-transitory computer-readable medium of claim 1, wherein the instructions are further executable by the processor to:
provide a standard code parameter to the artificial intelligence interface; and
instruct the artificial intelligence interface to create the code file according to the standard code parameter.

7. The non-transitory computer-readable medium of claim 1, wherein the instruction for the artificial intelligence interface includes:
a condition to the user prompt;
instructions to analyze an existing code file; and
a response format.

8. A method, comprising:
receiving a user prompt;
translating the user prompt into an instruction for an artificial intelligence interface;
transmitting the instruction to the artificial intelligence interface;
receiving a code file from the artificial intelligence interface;
building an executable software program from the code file;
determining whether a build error exists in the executable software program; and
debugging the executable software program.

9. The method of claim 8, comprising:
drafting a second instruction to the artificial intelligence interface based on the build error; and
transmitting the second instruction to the artificial intelligence interface.

10. The method of claim 8, comprising:
comparing, during the debugging, a variable in the executable software program to an expected value;
drafting, when the variable does not match the expected value, a third instruction to the artificial intelligence interface when the variable does not match the expected value; and
transmitting the third instruction to the artificial intelligence interface.

11. The method of claim 8, wherein translating the user prompt into the instruction for the artificial intelligence interface includes instructing the artificial intelligence interface to insert a breakpoint in the code file.

12. The method of claim 8, wherein the user prompt includes a path identification to a software code in which the code file is to be included.

13. The method of claim 8, comprising:
providing a standard code parameter to the artificial intelligence interface; and
instructing the artificial intelligence interface to create the code file according to the standard code parameter.

14. The method of claim 8, wherein the instruction for the artificial intelligence interface includes:
a condition to the user prompt;
instructions to analyze an existing code file; and
a response format.

15. A system, comprising:
a processor; and
a non-transitory computer-readable medium, the non-transitory computer-readable medium including instructions executable by the processor to:
receive a user prompt;
translate the user prompt into an instruction for an artificial intelligence interface;
transmit the instruction to the artificial intelligence interface;
receive a code file from the artificial intelligence interface;
build an executable software program from the code file;
determine whether a build error exists in the executable software program; and
debug the executable software program.

16. The system of claim 15, wherein the instructions are further executable by the processor to:
draft a second instruction to the artificial intelligence interface based on the build error; and
transmit the second instruction to the artificial intelligence interface.

17. The system of claim 15, wherein the instructions are further executable by the processor to:
compare, during the debugging, a variable in the executable software program to an expected value;
draft, when the variable does not match the expected value, a third instruction to the artificial intelligence interface when the variable does not match the expected value; and
transmit the third instruction to the artificial intelligence interface.

18. The system of claim 15, wherein translating the user prompt into the instruction for the artificial intelligence interface includes instructing the artificial intelligence interface to insert a breakpoint in the code file.

19. The system of claim 15, wherein the instructions are further executable by the processor to:
provide a standard code parameter to the artificial intelligence interface; and
instruct the artificial intelligence interface to create the code file according to the standard code parameter.

20. The system of claim 15, wherein the instruction for the artificial intelligence interface includes:
a condition to the user prompt;
instructions to analyze an existing code file; and
a response format.
